(19) United States
(12) Patent Application Publication
(10) Pub. No.: US 2017/0226790 A1
(43) Pub. Date: Aug. 10, 2017

(54) SELF-OPENING COOLER COMPRISING THREE DOOR PARTS

(71) Applicant: Red Bull GmbH, Fuschl am See (AT)

(72) Inventors: Juergen Brenneis, Pinsdorf (AT); Roland Concin, Stallehr (AT)

(21) Appl. No.: 15/503,262

(22) PCT Filed: Aug. 13, 2015
(86) PCT No.: PCT/EP2015/068621

§ 371 Date: Feb. 10, 2017

(30) Foreign Application Priority Data
Aug. 13, 2014 (EP) 14180887.3

(51) Int. Cl. E05F 15/79; A47F 3/04; E05D 15/18; E05F 15/60; F25D 23/02; E05D 15/22

(52) U.S. Cl. CPC E05F 15/79; F25D 23/021; E05D 15/22; E05D 15/18; E05F 15/60; A47F 3/0434; F25D 2700/04; E05Y 2900/306

(57) ABSTRACT

An automatic sliding door system includes a door frame having a first end and an opposite second end, configured and adapted for placement at a housing of a cooler; an at least three-parting door connected to the door frame, the at least three-part door including a first door part, a second door part and a third door part, each door part slidably connected to the door frame and in some cases each door part having a rectangular shape; and at least one drive element configured and adapted for moving the first, second and/or third door part. The present disclosure also relates to a cooler with such an automatic sliding door system.

### BACKGROUND

Technical Field

The present disclosure provides an automatic sliding door system and a cooler employing such an automatic sliding door system.

Description of the Related Art

According to the state of the art, coolers without doors are used within, e.g., supermarkets for cooling foods, like, e.g., beverages. One disadvantage of said open coolers is that there is a waste of energy due to migration of atmosphere from the surrounding environment, which has a higher temperature, into the inside of said coolers. The alternatively known coolers with swing or sliding doors to reduce such energy loss have the disadvantage that the customers will have to open the cooler doors manually. Such a manual opening is time consuming and may prevent customers to buy the products kept in said coolers. Therefore, coolers with doors are mainly used for low temperature coolers, e.g., freezers.

It is also well known in the state of the art to provide coolers with automatic swing doors. When opening such a swing door of a cooler there is the problem of a particularly high force that needs to be overcome in order to cope with the vacuum which develops inside the cooler when the door is closed. Furthermore, for being able to provide a good insulation, the contacting pressure by closing the door has to be high as well. And, the thermally insulated doors themselves are in general heavy and require high torques for being pivoted.

Therefore, the drive devices for opening and closing an automatic cooler door have to provide high forces and in particular a high torque that goes along with the risk of injuries for a user, e.g., if a hand of a user is between the housing and the door while closing the same.

Another disadvantage of known automatic swing doors for coolers is that there is a need for a complex sensor system to identify whether a door may be opened or closed safely without injuring a user.

Another disadvantage of the state of the art is that such swing doors need plenty of space to be opened and closed in front of a cooler and, in particular in the case that the cooler is located within a supermarket, the surrounding of the cooler has to be monitored to prevent injuries of customers passing by the cooler while opening the doors.

There is a need to overcome the disadvantages of the state of the art and in particular to provide an automatic cooler door system that is less space consuming and that requires low torques of the drive unit to improve safety. Furthermore, an automatic cooler door system shall be provided that allows a fast opening and closing of the doors, and that advantageously does not require a complex apparatus.

### BRIEF SUMMARY AND INITIAL DESCRIPTION

Accordingly, the present disclosure provides an automatic sliding door system, comprising a door frame, in some cases an insulated door frame, having a first end and an opposite second end, wherein the door frame is configured and adapted for placement at a housing of a cooler. The automatic sliding door system further comprises an at least three-part door connected to said door frame, said at least three-part door comprising a first door part, a second door part and a third door part and, if need be, at least one additional door part, each slidably connected to said door frame and each in some cases having a rectangular shape, and at least one drive element, in some cases one drive element, configured and adapted for moving the first, second and/or third, and, if need be, additional, door part, in some cases the first, second and third door part.

By using at least three, in some cases three, separate door parts that can individually be moved by the at least one, in some cases one, drive element, also referred to as drive unit, it is possible to open the cooler being equipped with the automatic sliding door mechanism of the present disclosure in short time and to provide access to the interior, e.g., trays of the cooler. It is of particular advantage that upon opening the entire cooler space, e.g., all trays being inside the cooler can be easily accessed. Of course, it is obvious for those skilled in the art that as well only one or a part of the at least three door parts may be moved by the drive unit to provide a partial opening of the cooler.

By using a sliding mechanism for moving the door parts instead of a swing mechanism, the torque forces needed can significantly be reduced, and the handling of the coolers is much safer and also less space consuming. Due to the latter fact, a cooler being equipped with the automatic sliding door mechanism of the present disclosure can be placed at locations which are not suited for conventional cooler types.

A cooler in the meaning of the present disclosure can be any apparatus having a compartment which can be cooled. The automatic sliding door system of the present disclosure can be used, for example, with refrigerators such as household refrigerators or refrigerators which are in commercial use such as back-bar refrigerators. Furthermore, so-called open front coolers as used in supermarkets or gas stations can as well be equipped with the automatic sliding door system of the present disclosure. That is, the automatic sliding door system can be used with such coolers which allow access to the cooled products from above. In this case, the door frame and some or all of the door parts can be placed in an essentially horizontal orientation. The automatic sliding door system of the present disclosure can also be used with such coolers which allow access from at least one side. In this case, the door frame and some or all of the door parts can be placed in an essentially vertical orientation.

The door frame of the automatic sliding door system of the present disclosure can, for example, comprise a circumferential construction, e.g., a construction in which a pair of laterally spaced apart guide rail elements are connected and thereby possibly stabilized either at one side (first or second side of the door frame) or at both the first and the second side of the frame.

The door parts of the automatic sliding door system of the present disclosure can be in the form of a panel, in some cases a transparent panel. Such door part can be made of glass or plastic, e.g., so-called acrylic glass. The door parts of the present disclosure can also be made of a single panel or of a set of two or more adjacent panels having either vacuum or any gas between such adjacent panels. In at least one embodiment, heat insulated door parts can be used. It has been found to be pragmatic to make use of door parts having an essentially rectangular shape, e.g., a quadratic shape.

As outlined above, the door frame of the present disclosure as well as its door parts can be placed in an essentially horizontal or in an essentially vertical orientation. There are also cooler embodiments in which said door frame and its door parts are oriented in an oblique position. If placed in an essentially vertical orientation, the first side of the door frame shall be at the top side and the opposite second side of the door frame shall be at the bottom side. And similarly a first edge of the first, second and third door part shall be located at the top, i.e., above a second edge of said first, second and third door parts, respectively. In general, irrespective of the orientation of the automatic sliding door system, the first edge of the first, second and third door parts shall be oriented towards the first side of the door frame and the respective opposite second edges of the first, second and third door parts shall be oriented towards the second side of the door frame.

If placed in an essentially vertical orientation or even when placed in an oblique orientation, the dimension of the door parts from the first edge to the respective opposite second edge can be assigned a height. If placed in an essentially horizontal orientation, the dimension between the first and respective second edge of a door part can be better addressed as width or length.

According to at least one embodiment of the present disclosure, the automated sliding door mechanism further comprises according to a first variant (variant “a)”) at least a first guide rail element having a first end and an opposite second end, wherein the sliding of the first door part is guided by said first guide rail element; and at least a second guide rail element having a first end and an opposite second end, wherein the sliding of the second door part and the third door part is guided by said second guide rail element, wherein the first and the second guide rail elements are arranged at or integrated in the door frame; or according to a second variant (variant “b)”) at least a first guide rail element having a first end and an opposite second end, wherein the sliding of the first door part is guided by said first guide rail element; at least a second guide rail element having a first end and an opposite second end, wherein the sliding of the second door part is guided by said second guide rail element; and at least a third guide rail element having a first end and an opposite second end, wherein the sliding of the third door part is guided by said third guide rail element, wherein the first, the second and the third guide rail elements are arranged at or integrated in the door frame. It has been found that the first variant a) is advantageous for most applications as usually both the second and the third door part can be guided in one and the same guide rail element thereby taking up much less space.

By the help of the first, the second and/or the third guide rail elements, the sliding of the first, the second and/or the third door part can be guided along desired directions. The respective guide rail elements are configured and adapted to keep the door parts in the desired position both during the sliding movement and when at rest. This can be accomplished in at least one embodiment by one guide rail element per door part. It usually is the side or edge of the door part which extends from the top or first edge to the bottom or second edge that engages with the guide rail element. According to another embodiment, the first, the second and/or the third guide rail elements, in some cases the first, the second and the third guide rail elements, comprise a pair of guide rails to guide two opposite sides or edges of the first, the second and/or the third door part, respectively.

According to at least one embodiment of the present disclosure, it may be of advantage that the first door part has a surface that is at least partially curved and the first guide rail element is, at least in sections, curved, in some cases correspondingly to said curved surface of the first door part. By use of such curved first guide rail element, a cooler can be tightly sealed with the automatic sliding door system of the present disclosure.

Furthermore, by the use of the first door part having an at least partially curved surface and of a corresponding first guide rail element, it may be possible to provide a space saving top or bottom door part element that allows a fast opening of the automatic sliding door system. In some cases, in case the remaining door part elements are sliding in a direction opposite to the first door part element when opened or closed, the opening and closing, respectively, of the door part elements can be fastened.

Moreover, according to at least one embodiment of the present disclosure, it is rather suitable in some cases that the second guide rail element and the third guide rail element are, at least in sections, arranged spaced apart from and, in some cases at least in sections, parallel to each other, wherein the second guide rail element has a length of at least a sum the respective heights or the widths of the second door part and the third door part and the third guide rail element has a length of at least the height or the width of third door part.

By arranging the second and the third guide rail elements, at least in sections, in parallel to each other, it may be possible that the second and the third door part are in a parallel position in an open state of the automatic sliding door system. This is of advantage to optimize the access to the interior space for products of a cooler. For example, it is possible that both the second and the third door parts are arranged in parallel next to the bottom or the top of a cooler, a location where in general the compressor and other components of coolers are located, and anyway no inside space for products can be provided. It is of course also possible, and in most instances rather suitable, to slide both the second door part and the third door part in the second guide rail element. Here, at least that part of the second guide rail element which accommodates the second and the third door part in the closed state needs to be configured and adapted to accomplish this task. It may as well be of advantage according to at least one embodiment of the present disclosure that a first end of the first guide rail element is arranged at or next to the first end of the door frame and/or the second end of the second guide rail element and/or the second end of the third guide rail element are arranged at or next to a second end of the door frame, wherein the first end of the door frame is arranged at the side opposite to the second end of the door frame. This kind of arrangement allows movement of the first door part in a direction opposite to that of the second and the third door part during opening and/or closing. In this manner the time needed for opening and closing of the door parts can be shortened. Sliding pathways having a minimized length can be accomplished.

According to at least one embodiment of the present disclosure, it is pragmatic in some cases that the sliding direction for opening the automatic sliding door system of the first door part is opposite to the sliding direction of the second and/or the third door part, in some cases opposite to the sliding direction of the second and the third door part. This allows a fast opening and closing of the door parts.

According to at least one embodiment of the present disclosure, it may be rather suitable in some cases that the second ends of the first, the second and/or the third guide rail elements are arranged opposite to the first ends of the first, the second and the third guide rail elements, respectively, wherein in some cases the second end of the first guide rail element is arranged adjacent to the first end of the second guide rail element and the first end of the third guide rail element is spaced apart from the second end of the first guide rail element and from the first end of the second guide rail element, in some cases at a distance of and/or corresponding to the height or width of the second door part.

This should allow that, in the closed state of the automatic sliding door system, all door parts are arranged next to and/or adjacent to each other. If, for example, the first, second and third door parts have a rectangular shape, adjacent edges of the first and second door part and adjacent edges of the second and third door part can adjoin each other.

According to a further embodiment of the present disclosure, it can be of advantage that in a closed state of the automatic sliding door system, the second edge of the first door part is arranged adjacent to or adjoining or overlapping a first edge of the second door part and a first edge of the third door part is arranged adjacent to or adjoining or overlapping a second edge of the second door part, wherein the first edge and the second edge of the second door part are opposite edges of the second door part, wherein the second edge of the first door part is opposite its first edge, said first edge being closer to the first end of the door frame than the second edge of the first door part, and wherein the first edge of the third door part is opposite its second edge said second edge being closer to the second end of the door frame than the first edge of the third door part. Thereby a good barrier can be provided for preventing migration of the warmer air from the surrounding environment into the inside of a cooler where a lower temperature is kept.

According to at least one embodiment of the present disclosure, it may be of advantage that in an open state of the automatic sliding door system the first door part, in some cases a first edge of the first door part, is arranged at or next to the first end of the first guide rail element and the second and third door parts, in some cases second edges of the second and the third door parts, are arranged at or next to the second end of the second and the third guide rail element respectively, wherein the second and the third door parts are arranged in some cases, at least partially, in parallel to each other. In such a manner the second door part can partially or completely cover the third door part, or vice versa.

Thereby, access may be provided to a user to the inside of the cooler while only small parts of the cooler are covered by the door parts.

Moreover, according to at least one embodiment of the present disclosure, it may be of advantage that the automatic sliding door system of the present disclosure comprises a sensor unit coupled to a controller that is configured and adapted for activating a movement of the first, second and/or third door part, wherein said sensor unit comprises a motion sensor.

According to at least one embodiment of the present disclosure, it may be suitable in some cases that the sensor unit is configured and adapted to generate a motion detection signal that causes the controller to activate an opening of the first, the second and/or the third door part, wherein in some cases the controller is configured to activate a closing of the first, the second and/or the third door part after a predetermined time interval without receiving a motion detection signal.

With the help of the sensor unit, an automated opening and closing of the door parts can be provided. It is of course also possible to actuate opening and/or closing by any other operating mechanism, e.g., a button which, when pushed, activates the drive element.

According to at least one embodiment of the present disclosure, it may be of advantage that the sensor unit is configured and adapted to generate a motion detection signal only when detecting motion towards the automatic sliding door system, and is, in some cases, configured and adapted to thereafter continue to generate a motion detection signal until motion in at least one direction, in some cases in any direction, is no longer detected. This may be of advantage to open the cooler only in case of a user moving towards the cooler while users passing by the cooler do not activate the opening. In case the cooler is used in a supermarket or the like, a high frequency of customers may pass by a cooler only without being interested to buy products stored in the cooler so that there is no need for opening the cooler doors.

According to at least one embodiment of the present disclosure, it can be of advantage that the sensor unit further comprises at least one optical detector, in some cases at least one camera, at least one infrared sensor, at least one ultrasonic sensor and/or at least one heat sensor

Such sensors are of advantage for detecting a user, and in some cases to detect the movement direction of one or more users at the same time.

According to further embodiment of the present disclosure, it may be rather pragmatic in some cases that the at least one drive unit/drive element comprises at least one electric motor configured and adapted to move the first, the second and/or the third door part, in some cases the first, the second and the third door part, from an open state to or towards a closed state and/or vice versa. According to another embodiment, the drive unit comprises at least two electric motors, wherein a first electric motor is configured and adapted to open or close the first door part and a second electric motor is configured and adapted to open or close the second door part and the third door part. This may allow an opening or closing of the door parts individually, i.e., separate of each other.

In at least one embodiment of the automatic sliding door system of the present disclosure, at least one arrester, also called first arrester, for the first door part is provided configured and adapted to block a further movement of the first door part towards the second end of the door frame. In such a manner, optimal positioning of the first door part in the closed position can be accomplished. Said arrester may also serve to block the movement of the second door part in the direction of the first end of the frame. The arrester can aid in alleviating a correct positioning of the first door part thereby allowing for a good barrier of the cooled interior of a cooler and helping to avoid leakage of cold air. In such a manner the second edge of the first door part and the first edge of the second door part can butt joint.

In some optional embodiments of the automatic sliding door system of the present disclosure, the at least one drive unit/drive element comprises at least one electric motor, in some cases one electric motor, configured and adapted to move the second door part, in some cases from the open state to or towards the closed state and/or vice versa. According to a pragmatic embodiment, it is provided that the first and/or third door part, in some cases the first and third door parts, are connected to the second door part, i.e., the movement of the second door part, so that the first and/or third door part, in some cases the first and third door parts, are moved from the open state to the closed state and/or vice versa corresponding to the movement of the second door part. Such automatic sliding door system is, for example, rather suited in which the connection between the second door part and the first door part is configured and adapted in such a manner that the second and the first door part move in opposite directions both during closing and opening movement, and that the connection between the second door part and the third door part is configured and adapted in such a manner that the second and the third door part move in the same direction both during closing and opening movement.

In at least one embodiment, a drive unit is connected to the second door part only, in some cases, by way of a Bowden wire. In some further embodiments, said second door part is also connected to the first door part and the third door part, for example, in each case by way of a Bowden wire. The second door part can additionally be provided with at least one catch or tappet which is used in the movement of the second door part towards the second end of the door frame and which allows to carry the third door part together with the second door part towards the second end of the door frame when the second door part is moved by the drive unit. According to another suitable embodiment, the movement of the third door part towards the second end of the door frame is blocked by use of another, second arrester, in some cases if the door frame of the present disclosure is positioned in a vertical orientation. With such an embodiment the third door part, in some cases its second edge, that is, its lower edge is resting on said second arrester and said second door part is resting on the catch or tappet when in the open position. However, such catch or tappet is not a mandatory requirement; the second door part can also be kept in place by its connection to the drive unit, for example, via the Bowden wire. In the embodiment in which only the second door part is driven by the drive unit, opening and closing movement of the first door part can be accomplished by way of respective connection means, for example, Bowden wires. In order to allow for a smooth movement of the first, second and/or third door parts during opening and closing, respective belts drives can be used.

Furthermore, a problem underlying the present disclosure has been solved by a cooler comprising at least one automatic sliding door system according to the present disclosure.

Finally, it may also be pragmatic according to at least one embodiment of the present disclosure that the door frame is attached to or integrated with the cooler, such that the first door part on the one hand and the second and third door part on the other hand are configured and adapted to move in opposite directions during closing and opening movement. Here, such embodiments are rather suitable in some cases in which the door frame is attached to or integrated with the cooler essentially vertically such that the first door part is configured and adapted to open upwardly and to close downwardly and the second and the third door part are configured and adapted to open downwardly and to close upwardly.

A surprising finding of the present disclosure is that using at least three door parts that are slidably arranged within a frame allows a fast automatic opening and closing of a cooler, while additional space around the cooler is not needed.

### BRIEF DESCRIPTION OF THE SEVERAL VIEWS OF THE DRAWINGS

In the following description, the present disclosure is explained in more detail by means of a rather suitable embodiment relating to the enclosed drawings, wherein:

FIG. 1 is a schematic perspective view of an embodiment of an automatic sliding door system according to the present disclosure with closed door parts;

FIG. 2 is a schematic perspective view of an embodiment of an automatic sliding door system according to the present disclosure with partly opened door parts;

FIG. 3 is a schematic perspective view of an embodiment of an automatic sliding door system according to the present disclosure with opened door parts;

FIG. 4 is a schematic perspective view of an embodiment of a cooler comprising an automatic sliding door system according to the present disclosure with closed door parts; and

FIG. 5 is a schematic perspective view of an embodiment of a cooler comprising an automatic sliding door system according to the present disclosure with semi-opened door parts.

### DETAILED DESCRIPTION

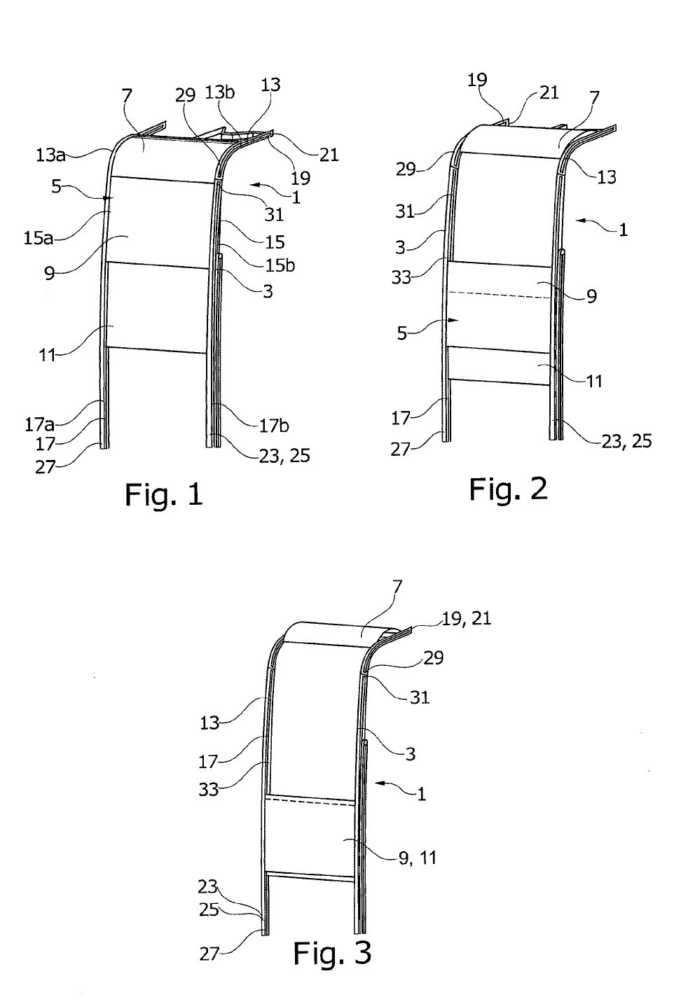

FIGS. 1 to 3 show schematic views of an embodiment of an automatic sliding door system according to the present disclosure with closed, semi-opened and opened door parts respectively.

The automatic sliding door system 1 comprises a insulated door frame 3. A three-part door 5 comprising a first door part 7, a second door part 9 and a third door part 11 is connected to said door frame 3, wherein each of the separate three door parts 7, 9, 11 are slidably connected to said door frame 3, and a drive element (not shown) is configured and adapted for moving the first, second and/or third door part 7, 9, 11.

A first guide rail element 13 to guide the sliding of the first door part 7, a second guide rail element 15 to guide the sliding of the second door part 9, and a third guide rail element 17 to guide the sliding of the third door part 11 is provided, wherein the first, the second and the third guide rail elements 13, 15, 17 are integrated within the door frame 3. Each guide rail element 13, 15, 17 may comprise a pair of guide grooves 13a, 13b; 15a, 15b; and 17a, 17b, respectively, as indicated in the figures. In the following, for the sake of brevity, said pair of guide grooves will be referred to as a guide rail element. It is also possible, and for most applications even rather suitable, that the second and third door parts 9 and 11 are guided by the second guide rail element 15 only.

The first door part 7 of the embodiment of FIG. 1 has a curved surface and the first guide rail element 13 is curved correspondingly to said curved surface of the first door part. This allows, as exemplarily shown in FIGS. 2 and 3, an upward opening of the first door part 7 in direction of the top of the door frame 3, i.e., towards the first end 21 of the door frame 3.

The second guide rail element 15 and the third guide rail element 17 are, over a section, arranged spaced apart or adjacent from and parallel to each other. The second guide rail element 15 extends spaced apart at a first distance from the bottom of the door frame 3 next to the bottom end of the first door part 7 in the closed state of the same.

A first end 19 of the first guide rail element 13 is arranged at or adjacent to a first, i.e., top end 21 of the door frame and the second ends 23, 25 of the second and the third guide rail element 15, 17 are arranged at a or next to a second, i.e., bottom end 27 of the door frame 3, wherein the first, i.e., top end 21 of the door frame 3 is arranged at the opposite side of the door frame 3 than the second, i.e., bottom end 27.

Second, i.e., the bottom or lower, ends 29, 23, 25 of the first, the second and/or the third guide rail elements 13, 15, 17 are arranged opposite to the first ends 19, 31, 33, respectively, and the second end 29 of the first guide rail element 13 is arranged adjacent to the first end 31 of the second guide rail element 15. The first end 33 of the third guide rail element 17 is spaced apart from the second end 29 of the first guide rail element 13 and also from the first end 31 of the second guide rail elements 15, in some cases at a distance corresponding to the length or height of the second door part 7.

As shown in FIG. 1, in a closed state of the automatic sliding door system 1, the second edge of the first door part 7 is arranged adjacent to or adjoining the first edge of the second door part 9 and a first edge of the third door part 11 is arranged adjacent to or adjoining the second edge of the second door part 9 to provide an insulation between the chilled interior of a cooler (not shown) and the warmer outside environment.

As shown in FIG. 2, the sliding direction for opening the automatic sliding door system 1 of the first door part 7 is opposite to the sliding direction of the second and the third door parts 9, 11.

As shown in FIG. 3, in an open state of the automatic sliding door system 1, the first door part 7 is arranged at the first end 19 of the first guide rail element 13 and the second and the third door parts 9, 11 are arranged at or adjacent to the first end of the second and the third guide rail elements 23, 25 respectively, in some cases their respective second edges, and the second and the third door parts 9, 11 are arranged essentially in parallel to each other.

With the help of a not shown sensor unit coupled to a not shown controller, the opening and closing of the door parts 7, 9, 11 can be controlled.

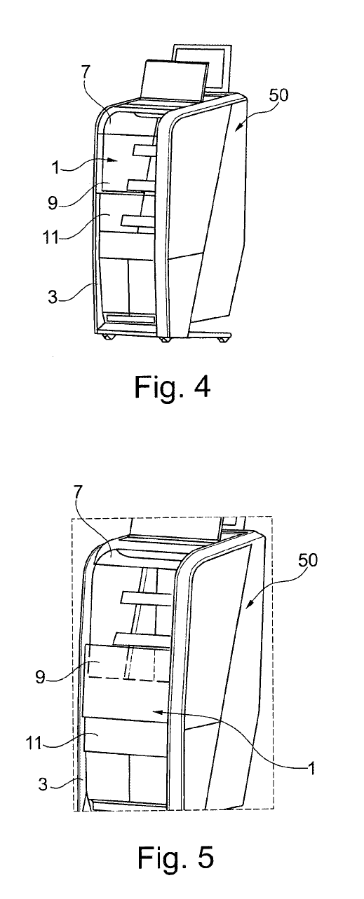

FIG. 4 shows a cooler 50 having an automatic sliding door system 1 according to FIGS. 1 to 3 in the closed state. FIG. 5 shows the cooler 50 of FIG. 4 with the door parts 7, 9, 11 partially opened.

The features of the present disclosure disclosed in the description above, in the claims and in the drawings can be used for implementing the present disclosure in its different embodiments both individually and in every possible combination thereof.

1. An automatic sliding door system, comprising:
door frame having a first end and an opposite second end, wherein the door frame is configured and adapted for placement at a housing of a cooler;
an at least three-part door connected to said door frame, said at least three-part door comprising a first door part, a second door part and a third door part, each door part slidably connected to said door frame; and
at least one drive element configured and adapted for moving the first, second and/or third door part.

2. The automatic sliding door system according to claim 1, further comprising:
a) at least a first guide rail element having a first end and an opposite second end, wherein the sliding of the first door part is guided by said first guide rail element; and
at least a second guide rail element having a first end and an opposite second end, wherein the sliding of the second door part and the third door part is guided by said second guide rail element;
wherein the first and the second guide rail elements are arranged at or integrated in the door frame, or
b) at least a first guide rail element having a first end and an opposite second end, wherein the sliding of the first door part is guided by said first guide rail element; and
at least a second guide rail element having a first end and an opposite second end, wherein the sliding of the second door part is guided by said second guide rail element; and
at least a third guide rail element having a first end and an opposite second end, wherein the sliding of the third door part is guided by said third guide rail element;
wherein the first, the second and the third guide rail elements are arranged at or integrated in the door frame.

3. The automatic sliding door system according to claim 2, wherein the first door part has surface that is at least partially curved, and the first guide rail element is, at least in sections, curved.

4. The automatic sliding door system according claim 2, wherein the second guide rail element and the third guide rail element are, at least in sections, arranged spaced apart from and, at least in sections, parallel to each other, wherein the second guide rail element has a length of at least a sum of respective heights or widths of the second door part and the third door part, and the third guide rail element has a length of at least the height or the width of third door part.

4. The automatic sliding door system according to claim 2, wherein the first end of the first guide rail element is arranged at or next to the first end of the door frame and/or the second end of the second guide rail element and/or the second end of the third guide rail element are arranged at or next to the second end of the door frame, wherein the first end of the door frame is arranged at the side of the door frame opposite to the second end of the door frame.

6. The automatic sliding door system according claim 2, wherein the second end of the first guide rail element is arranged adjacent to the first end of the second guide rail element and the first end of the third guide rail element is spaced apart from the second end of the first guide rail element and from the first end of the second guide rail element.

7. The automatic sliding door system according to claim 1, wherein in a closed state of the automatic sliding door system, a second edge of the first door part is arranged adjacent to or adjoining or overlapping a first edge of the second door part, and a first edge of the third door part is arranged adjacent to or adjoining or overlapping a second edge of the second door part, wherein the first edge and the second edge of the second door part are opposite edges of the second door part, wherein the second edge of the first door part is opposite its first edge, said first edge of the first door part being closer to the first end of the door frame than the second edge of the first door part, and wherein the first edge of the third door part is opposite its second edge, said second edge of t he third door part being closer to the second end of the door frame than the first edge of the third door part.

8. The automatic sliding door system according to claim 1, wherein a sliding direction for opening the automatic sliding door system of the first door part is opposite to a sliding direction of the second and the third door part.

9. The automatic sliding door system according to claim 2, wherein, in an open state of the automatic sliding door system, a first edge of the first door part is arranged at or next to the first end of the first guide rail element and second edges of the second and the third door parts are arranged at or next to the second end of the second and the third guide rail elements respectively.

10. The automatic sliding door system according to claim 1, further comprising a sensor unit coupled to a controller configured and adapted for activating a movement of the first, second and/or third door part, wherein said sensor unit comprises a motion sensor.

11. The automatic sliding door system according to claim 10, wherein the sensor unit is configured and adapted to generate a motion detection signal that causes the controller to activate an opening of the first, the second and/or the third door part.

12. The automatic sliding door system according claim 10, wherein the sensor unit is configured and adapted to generate a motion detection signal only when detecting motion towards the automatic sliding door system.

13. The automatic sliding door system according to claim 10, wherein the sensor unit comprises at least one optical detector, at least one infrared sensor, at least one ultrasonic sensor and/or at least one heat sensor.

14. The automatic sliding door system according to claim 2, wherein the first, the second and/or the third guide rail elements comprise a pair of guide rails to guide two opposite sides of the first, the second and/or the third door part, respectively.

15. The automatic sliding door system according to claim 1, wherein the at least one drive element comprises at least one electric motor configured and adapted to move the first, the second or the third door part, or the first, the second and the third door part, from an open state to or towards a closed state and/or vice versa.

16. The automatic sliding door system according to claim 1, wherein the at least one drive element comprises at least one electric motor configured and adapted to move the second door part.

17. The automatic sliding door system according to claim 16, wherein the first and/or third door part are connected to the second door part so that the first and/or third door part are moved from the open state to the closed state and/or vice versa corresponding to the movement of the second door part.

18. The automatic sliding door system according to claim 17, wherein the connection between the second door part and the first door part is configured and adapted in such a manner that the second and the first door part move in opposite directions both during closing and opening movement, and that the connection between the second door part and the third door part is configured and adapted in such a manner that the second and the third door part move in the same direction both during closing and opening movement.

19. The automatic sliding door system according to claim 1, further comprising an arrester for the first door part configured and adapted to block a further movement of the first door part towards the second end of the door frame.

20. A cooler comprising at least one automatic sliding door system according to claim 1.

21. The cooler according to claim 20, wherein the door frame is attached to or integrated with the cooler, such that the first door part on the one hand and the second and third door part on the other hand are configured and adapted to move in opposite directions during closing and opening movement.

22. The cooler according to claim 21, wherein the door frame is attached to or integrated with the cooler essentially vertically such that the first door part is configured and adapted to open upwardly and to close downwardly and the second and the third door parts are configured and adapted to opened downwardly and to close upwardly.

23. The automatic sliding door system according to claim 1, wherein the door frame is an insulated door frame.

24. The automatic sliding door system according to claim 3, wherein the first guide rail element is, at least in sections, curved corresponding to said curved surface of the first door part.

25. The automatic sliding door system according to claim 6, wherein the first end of the third guide rail element is spaced apart from the second end of the first guide rail element and from the first end of the second guide rail element at a distance of and/or corresponding to the length or width of the second door part.

26. The automatic sliding door system according to claim 9, wherein the second and the third door parts are arranged at least partially in parallel to each other.

27. The automatic sliding door system according to claim 11, wherein the controller is configured to activate a closing of the first, the second and/or the third door part after a predetermined time interval without receiving a motion detection signal.

28. The automatic sliding door system according to claim 12, wherein the sensor unit is configured and adapted to, after having detected motion towards the automatic sliding door system, continue to generate a motion detection signal until motion in at least one direction or in in any direction is no longer detected.

29. The automatic sliding door system according to claim 16, wherein the at least one electric motor is configured and adapted to move the second door part from an open state to or towards a closed state and/or vice versa.
